(19) United States
(12) Patent Application Publication
(10) Pub. No.: US 2007/0279354 A1
(43) Pub. Date: Dec. 6, 2007

(54) DISPLAY DEVICE AND DRIVING METHOD THEREOF

(76) Inventor: Sang-Hoon Yim, Yongin-si (KR)

Correspondence Address: CHRISTIE, PARKER & HALE, LLP, PO BOX 7068, PASADENA, CA, 91109-7068, US

(21) Appl. No.: 11/750,944

(22) Filed: May 18, 2007

(30) Foreign Application Priority Data
Jun. 1, 2006 (KR) 10-2006-0049545

(51) Int. Cl. G09G 3/36

(52) U.S. Cl. 345/87

(57) ABSTRACT

A display device having a plurality of pixels, each of the plurality of pixels having three subpixels of which centers form a triangle and of which a direction of a side of the triangle is horizontal with respect to the displayed image is provided. In the display device, when a black line or a white line is displayed, video signal data of upper and lower pixels adjacent to the black line or the white line are converted to video signal data that is cyan-biased or magenta-biased. Accordingly, visibility and readability of a character can be increased.

### CROSS-REFERENCE TO RELATED APPLICATION

This application claims priority to and the benefit of Korean Patent Application No. 10-2006-0049545 filed in the Korean Intellectual Property Office on June 01, 2006, the entire content of which is incorporated herein by reference.

### BACKGROUND OF THE INVENTION

1. Field of the Invention

The present invention relates to a display device and a driving method thereof. More particularly, the present invention relates to a driving method of a plasma display device including a plasma display panel (PDP).

2. Description of the Related Art

A plasma display device is a display device using a PDP that displays characters or images using plasma that is generated by a gas discharge.

The PDP can embody a large screen of 60 inches or more in a thickness within only 10 cm, and has characteristics such that there is no distortion phenomenon depending on color representation and it has a viewing angle as good as a self-emitting display device such as a CRT.

The PDP includes a three-electrode surface-discharge type of PDP. The three-electrode surface-discharge type of PDP includes a substrate having sustain electrodes and scan electrodes that are positioned in the same plane, and another substrate having address electrodes that are perpendicular to the sustain and scan electrodes, and spaced apart by a predetermined distance from the substrate. A discharge gas is filled between the substrates.

In the PDP, a discharge is determined by individually controlled scan electrodes and address electrodes that are connected to separate lines, and a sustain discharge for displaying on a screen is performed by the sustain electrode and the scan electrode that are positioned in the same plane.

In general, in a PDP having a stripe type of barrier rib structure, one pixel includes red, green, and blue discharge cells, which are three subpixels adjacent to each other among discharge cells, and arrangement of the subpixels is always identical. That is, the pixels are regularly arranged in vertical and horizontal lines of the panel such that an image can be displayed. Accordingly, in a PDP having a stripe type of barrier rib structure, when expressing a character, the readability of a character is not deteriorated.

However, unlike the stripe type of barrier rib structure, a different arrangement exists between subpixels in a structure of a PDP in which centers of three subpixels constituting one pixel form a triangle shape. If suitable compensation is not performed when a different arrangement between the subpixels exists, readability of a character is deteriorated.

### SUMMARY OF THE INVENTION

In accordance with the present invention, a plasma display device and a driving method thereof are provided having an improved image in a plasma display device including a PDP in which centers of subpixels form a triangle shape.

An exemplary embodiment of the present invention provides a driving method of a display device that includes a plurality of pixels, each of the plurality of pixels having three subpixels, centers of the subpixels forming a triangle and a direction of a side of the triangle being horizontal with respect to a displayed image. The driving method includes converting first unprocessed video signal data of an upper pixel adjacent to a black line or a white line to first processed video signal data that is cyan-biased or magenta-biased, the first unprocessed video signal data being converted when the black line or the white line is displayed including at least one pixel in a horizontal direction with respect to the display image. The driving method also includes, converting second unprocessed video signal data of a lower pixel adjacent to the black line or the white line to second processed video signal data that is cyan-biased or magenta-biased, the second unprocessed video signal data being converted when the black line or the white line is displayed. In addition, the driving method includes displaying the first processed video signal data and the second processed video signal data in the display device.

Converting the first unprocessed video signal data includes converting the first unprocessed video signal data such that the first processed video signal data displays a cyan-biased color and a magenta-biased color are alternately arranged.

Converting the second unprocessed video signal data includes converting the second unprocessed video signal data so that the second processed video signal data displays a magenta-biased color and a cyan-biased color alternately arranged.

Converting the first unprocessed video signal data includes converting the first unprocessed video signal data of the upper pixel by reflecting video signal data of vertical pixels adjacent to the upper pixel to video signal data of the upper pixel. In addition, converting the second unprocessed video signal data includes converting second unprocessed video signal data of the lower pixel by reflecting video signal data of vertical pixels adjacent to the lower pixel to video signal data of the lower pixel.

Another embodiment of the present invention provides a driving method of a display device having a plurality of pixels, each of the plurality of pixels having three subpixels, centers of the subpixels forming a triangle and a direction of a side of the triangle being horizontal with respect to a display image. The driving method includes converting unprocessed video signal data to processed video signal data for each of the plurality of pixels by reflecting unprocessed video signal data of vertical pixels adjacent to each of the plurality of pixels. In addition, the method includes calculating a first dispersion, the first dispersion being a dispersion between subpixels of each of the plurality of pixels using the unprocessed video signal data. Furthermore, the method includes calculating a second dispersion, the second dispersion being a dispersion between subpixels of each of the plurality of pixels using the processed video signal data. Also, the method includes reconverting processed video signal data of a corresponding each of the plurality of pixels to unprocessed video signal data when the second dispersion is less than or equal to the first dispersion.

Yet another embodiment of the present invention provides a display device. The display device includes a plurality of row electrodes, a plurality of column electrodes, a direction of the plurality of column electrodes intersecting a direction of the plurality of row electrodes, and a plurality of pixels each defined by the plurality of row electrodes and the plurality of column electrodes. The display device also includes a display panel in which each of the plurality of pixels includes three subpixels with centers forming a triangle and in which a direction of a side of the triangle is a first direction, the first direction extending in the direction of the plurality of row electrodes. The display device also includes a controller that generates a control signal for driving the plurality of row electrodes and the plurality of column electrodes from input video signal data. The display device also includes a driver that drives the plurality of row electrodes and the plurality of column electrodes according to the control signal, wherein the controller converts unprocessed video signal data of vertical pixels adjacent to a black horizontal line to processed video signal data that is cyan-biased or magenta-biased, when a black horizontal line, which includes at least one pixel and whose direction is the same as the first direction, is displayed.

The controller may convert unprocessed video signal data of the upper pixel so that processed video signal data that is cyan-biased and processed video signal data that is magenta-biased are alternately arranged in the upper pixel adjacent to the black horizontal line. Furthermore, the controller may convert unprocessed video signal data of the lower pixel such that processed video signal data that is magenta-biased and processed video signal data that is cyan-biased are alternately arranged in the lower pixel adjacent to the black horizontal line.

The controller may convert unprocessed video signal data of vertical pixels adjacent to a white horizontal line to processed video signal data that is cyan-biased or magenta-biased, when the white horizontal line, which includes at least one pixel and whose direction is to the same as the first direction, is displayed. The controller may convert unprocessed video signal data of the upper pixel so that processed video signal data that is magenta-biased and processed video signal data that is cyan-biased are alternately arranged in the upper pixel adjacent to the white horizontal line, and convert unprocessed video signal data of the lower pixel so that processed video signal data that is cyan-biased and processed video signal data that is magenta-biased are alternately arranged in the lower pixel adjacent to the white horizontal line.

The controller may include a rendering processor for converting unprocessed video signal data of each of the plurality of pixels by reflecting unprocessed video signal data of vertical pixels adjacent to each of the plurality of pixels. In addition, the controller may include a feedback processor for calculating a first dispersion and a second dispersion, the first dispersion being a dispersion between three subpixels of each of the plurality of pixels using the input video signal data, the second dispersion being a dispersion between subpixels of each pixel using the processed video signal data that are converted by the rendering processor, and for reconverting processed video signal data that are converted by the rendering processor to unprocessed video signal data when the second dispersion is less than or equal to the first dispersion.

### BRIEF DESCRIPTION OF THE DRAWINGS

FIG. 1 is a schematic view of a plasma display device according to an exemplary embodiment of the present invention.

FIG. 2 is a top plan view illustrating a portion of pixels and an electrode arrangement of a PDP according to an exemplary embodiment of the present invention.

FIG. 3A is a view conceptionally illustrating a method of converting and alternately arranging video signal data of upper and lower pixels adjacent a black horizontal line to video signal data that is alternately cyan-biased and magenta-biased.

FIG. 3B is a view conceptionally illustrating a method of converting and alternately arranging video signal data of upper and lower pixels adjacent a black vertical line to video signal data that is alternately cyan-biased and magenta-biased.

FIG. 4A is a view conceptionally illustrating a method of converting and alternately arranging video signal data of upper and lower pixels adjacent a white horizontal line to video signal data that is alternately cyan-biased and magenta-biased.

FIG. 4B is a view conceptionally illustrating a method of converting and alternately arranging video signal data of upper and lower pixels adjacent a white vertical line to video signal data that is alternately cyan-biased and magenta-biased.

FIG. 5 is a partial block diagram of a controller of FIG. 1.

FIG. 6 is a view illustrating arrangement of pixels in a pixel structure of the PDP as in FIG. 2.

FIG. 7A is a view illustrating a case of applying Equations 1 to 6 to video signal data of a black horizontal line.

FIG. 7B is a view illustrating a case of applying Equations 1 to 6 to video signal data of a white horizontal line.

FIG. 8A is a view illustrating final video signal data of the video signal data as in FIG. 7A.

FIG. 8B is a view illustrating final video signal data of the video signal data as in FIG. 7B.

### DETAILED DESCRIPTION

In the specification, when it is said that any part is “connected” to another part, it means the part is “directly connected” to the other part or “electrically connected” to the other part with at least one intermediate part.

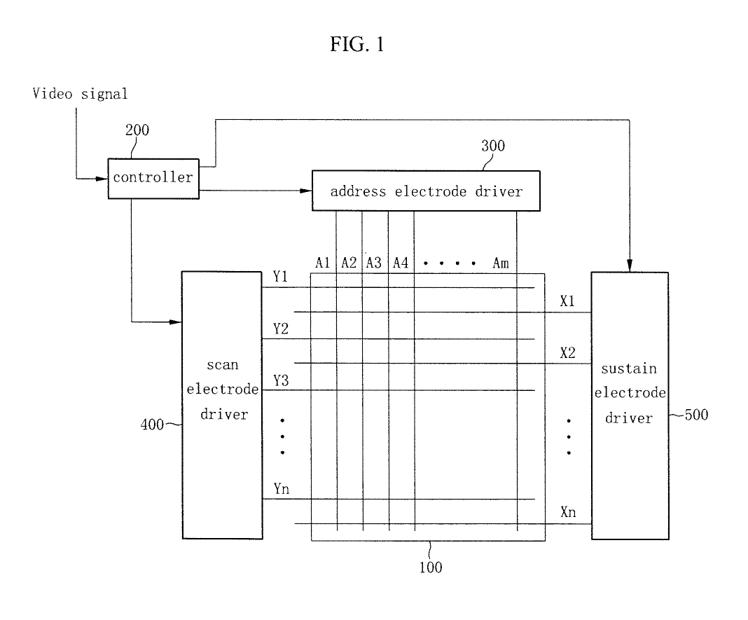

FIG. 1 is a schematic view of a plasma display device according to an exemplary embodiment of the present invention.

As shown in FIG. 1, the plasma display device according to an exemplary embodiment of the present invention includes a PDP 100, a controller 200, an address electrode driver 300, a scan electrode driver 400, and a sustain electrode driver 500.

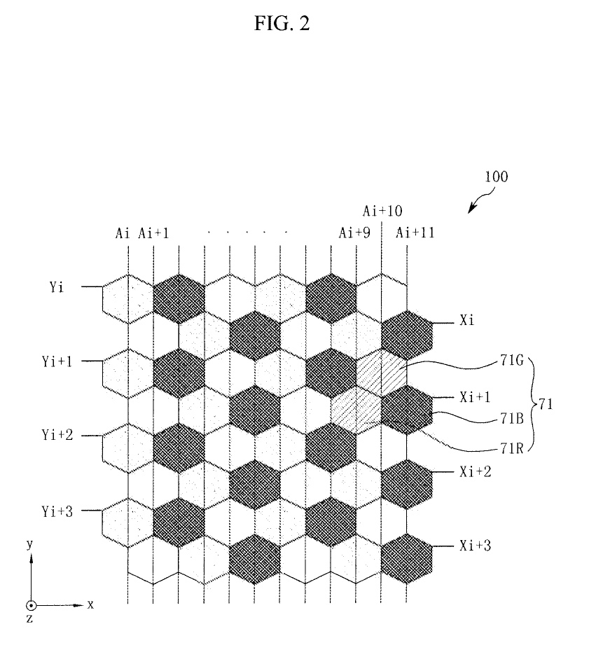

The PDP 100 includes a plurality of row electrodes that extend in a row direction and perform a scanning function and a display function, and a plurality of column electrodes that extend in a column direction and perform an address function. In FIG. 1, the column electrodes are shown as address electrodes A1-Am and the row electrodes are shown as sustain electrodes X1-Xn and scan electrodes Y1-Yn forming pairs. FIG. 2 shows a more detailed structure of the PDP 100 according to the exemplary embodiment of the present invention shown in FIG. 1.

The controller 200 receives a video signal from the outside, outputs an address driving control signal, a sustain electrode driving control signal, and a scan electrode control signal, and divides one field into a plurality of subfields each having a weight value. Each subfield includes an address period for selecting a discharge cell to emit light among a plurality of discharge cells, and a sustain period for performing a sustain discharge of a discharge cell that is selected as a discharge cell to emit light in the address period during a period corresponding to a weight value of the corresponding subfield.

The address electrode driver 300 receives an address electrode driving control signal from the controller 200, and applies a display data signal for selecting a discharge cell to display to the address electrodes A1-Am. The scan electrode driver 400 receives a scan electrode driving control signal from the controller 200, and applies a driving voltage to the scan electrodes Y1-Yn. The sustain electrode driver 500 receives a sustain electrode driving control signal from the controller 200, and applies a driving voltage to the sustain electrodes X1-Xn.

Next, a PDP according to an exemplary embodiment of the present invention will be described with reference to FIG. 2.

FIG. 2 is a top plan view illustrating a portion of pixels and an electrode arrangement of a PDP according to an exemplary embodiment of the present invention.

As shown in FIG. 2, the PDP according to an exemplary embodiment of the present invention has a delta-type barrier rib structure. Each discharge cell is partitioned into an independent space by the delta-type barrier ribs (not shown), and one pixel 71 includes red, green, and blue subpixels 71R, 71G, 71B that form a triangle of the discharge cells and are arranged adjacent to each other. Because each of subpixels 71R, 71G, 71B has approximately a hexagonal shape, the barrier ribs (not shown) for partitioning the subpixels 71R, 71G, 71B (i.e., the discharge cells) also have a hexagonal shape.

That is, the PDP according to an exemplary embodiment of the present invention is a so-called delta-type PDP that forms one pixel with three subpixels for emitting red, green, and blue visible light arranged in a triangular shape. Two subpixels among the subpixels 71R, 71G, 71B are disposed in parallel and adjacent to each other in an x-axis direction, and this disposition forms a space that is suitable for a discharge by increasing a discharge space in an x-axis direction, thereby improving a margin. The two subpixels 71R, 71B correspond to one scan electrode (Yi+2).

Sustain electrodes (Xi-Xi+3) and scan electrodes (Yi-Yi+3) are formed in the x-axis direction. The sustain electrodes (Xi-Xi+3) and the scan electrodes (Yi-Yi+3) form a discharge gap corresponding to each other in each discharge cell (i.e., subpixel). The sustain electrodes (Xi-Xi+3) and the scan electrodes (Yi-Yi+3) are alternately arranged along the y-axis direction.

The address electrodes (Ai-Ai+11) are formed in the y-axis direction, and the address electrodes (Ai+9, Ai+10, Ai+11) are formed to pass through the subpixels 71R, 71G, 71B constituting one pixel 71, respectively.

In a PDP such as in an exemplary embodiment of the present invention, because centers of subpixels constituting one pixel form a triangle, readability is deteriorated when expressing characters.

Particularly, in a PDP such as in an exemplary embodiment of the present invention, centers of subpixels (71R, 71G, 71B in FIG. 2) constituting one pixel form a triangle and a direction of a side of the triangle is the same as that of a horizontal line (i.e., an x-axis direction) that is displayed in the PDP. Accordingly, when a black horizontal line or a white horizontal line of a character is expressed in the PDP, the horizontal line regularly touches a green subpixel and thus looks like a zigzag shape.

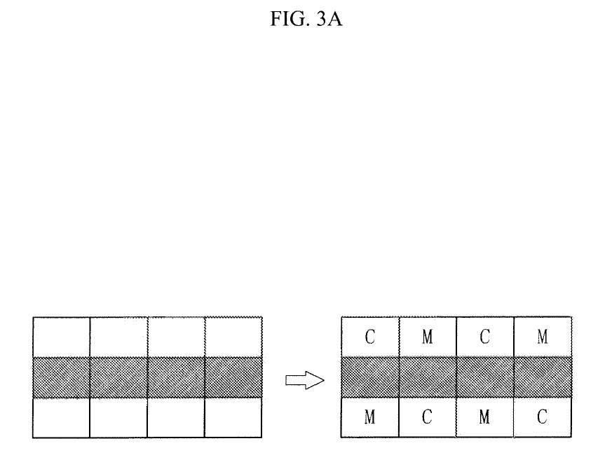

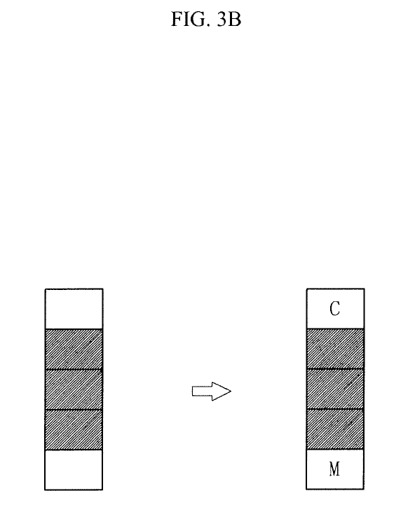

Hereinafter, when a different arrangement exists between the subpixels as described above, a method of improving the readability of a character will be described with reference to FIGS. 3 to 8.

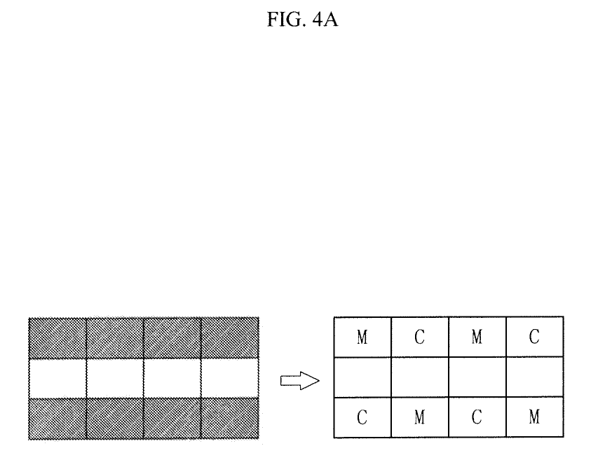

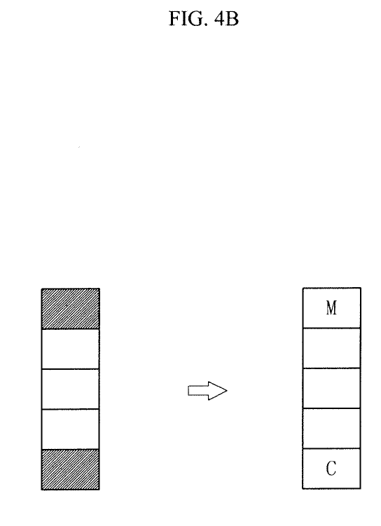

In order to solve the problem, in an exemplary embodiment of the present invention, as shown in FIGS. 3A and 4A, video signal data of upper and lower pixels adjacent a black horizontal line or a white horizontal line of the displayed character are converted to video signal data that is cyan-biased (or green-biased) and video signal data that is magenta-biased as compared with the original video signal data, and the converted cyan-biased and magenta-biased data are alternately disposed in adjacent pixels, thereby processing an image.

As used herein, the cyan-biased video signal data has a stronger shade of cyan component of color as compared with the original video signal data, and the magenta-biased video signal data has a stronger shade of magenta component of color as compared with the original video signal data.

FIG. 3A is a view conceptionally illustrating a method of converting and alternately arranging video signal data of upper and lower pixels adjacent a black horizontal line to video signal data that is alternately cyan-biased and magenta-biased. FIG. 4A is a view conceptionally illustrating a method of converting and alternately arranging video signal data of upper and lower pixels adjacent a white horizontal line to video signal data that is alternately cyan-biased and magenta-biased. In FIGS. 3A and 4A, a portion that is indicated with oblique lines indicates a pixel displaying black, a portion that is not indicated with oblique lines indicates a pixel displaying white, a portion ‘M’ indicates a portion that is converted from original video signal data to video signal data that is magenta-biased, and a portion ‘C’ indicates a portion that is converted from original video signal data to video signal data that is cyan-biased.

As shown in FIGS. 3A and 4A, in an exemplary embodiment of the present invention, video signal data of upper and lower pixels adjacent a black horizontal line or a white horizontal line are converted to video signal data that is cyan-biased (C) and magenta-biased (M) as compared with original video signal data, and the converted cyan-biased and magenta-biased data are alternately disposed in adjacent pixels.

As shown in FIG. 3A, video signal data of an upper pixel of a black horizontal line are converted to video signal data that is cyan-biased (C) and magenta-biased (M) as compared with the original video signal data and the converted data are alternately disposed (i.e., in an arrangement of C-M-C-M along a horizontal line direction), and video signal data of a lower pixel of a black horizontal line are converted to video signal data that is magenta-biased (M) and cyan-biased (C) as compared with the original video signal data and the converted data are alternately disposed (i.e., in an arrangement of M-C-M-C along a horizontal line direction). FIG. 3A shows that cyan (C) and magenta (M) are alternately disposed in upper and lower pixels of a horizontal line. However, insofar as magenta (M) and cyan (C) are alternately disposed in a horizontal line direction, video signal data of upper and lower pixels of a horizontal line may be disposed as magenta (M) and magenta (M) or cyan (C) and cyan (C) (i.e., in an arrangement of M-M-C-C along a horizontal line).

As shown in FIG. 4A, as in the black horizontal line, even in a white horizontal line, video signal data of upper and lower pixels adjacent to the white horizontal line is converted to video signal data that is magenta-biased (M) and cyan-biased (C) as compared with the original video signal data. FIG. 4A shows that magenta (M) and cyan (C) or cyan (C) and magenta (M) are alternately disposed in upper and lower pixels of a horizontal line. However, insofar as magenta (M) and cyan (C) are alternately disposed in a horizontal line direction, video signal data of upper and lower pixels of a horizontal line may be disposed as magenta (M) and magenta (M) or cyan (C) and cyan (C) (i.e., in an arrangement of M-M-C-C along a horizontal line).

In an exemplary embodiment of the present invention, as shown in FIGS. 3B and 4B, video signal data of upper and lower pixels of a black vertical line or a white vertical line are converted to video signal data that is cyan-biased (or green-biased), and video signal data that is magenta-biased as compared with the original video signal data and the converted data are alternately disposed in adjacent pixels, thereby processing an image.

FIG. 3B is a view conceptionally illustrating a method of converting and alternately arranging video signal data of upper and lower pixels of a black vertical line to video signal data that is alternately cyan-biased and magenta-biased. FIG. 4B is a view conceptionally illustrating a method of converting and alternately arranging video signal data of upper and lower pixels of a white vertical line to video signal data that is alternately magenta-biased and cyan-biased. As shown in FIG. 3B, video signal data of upper and lower pixels adjacent to a black vertical line are converted to video signal data that is alternately cyan-biased (C) and magenta-biased (M) as compared with the original video signal data, and the converted data are disposed in the pixels. As shown in FIG. 4B, video signal data of upper and lower pixels adjacent to a white vertical line are converted to video signal data that is magenta-biased (M) and cyan-biased (C) as compared with the original video signal data and the converted data are disposed in the pixels.

Next, a method of converting original video signal data of upper and lower pixels adjacent to a black horizontal line, a white horizontal line, a black vertical line, or a white vertical line to video signal data that is magenta-biased or cyan-biased will be described in detail.

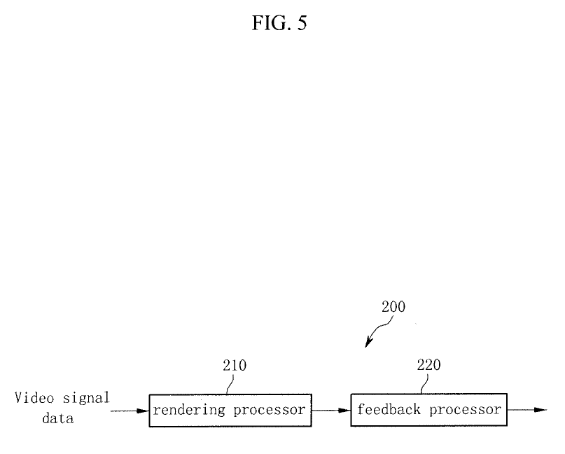

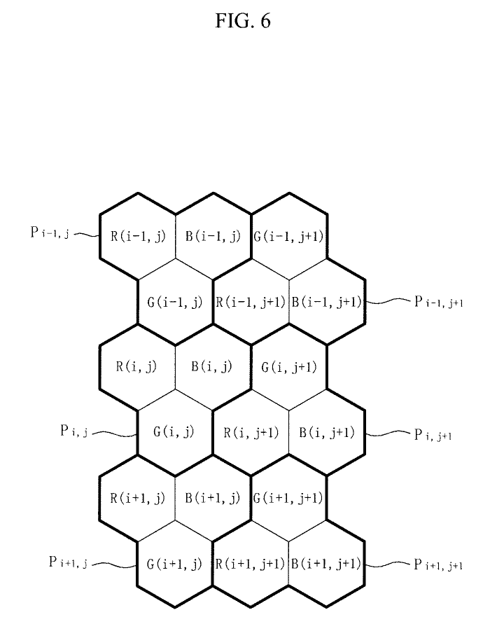

FIG. 5 is a partial block diagram of a controller of FIG. 1, and FIG. 6 is a view illustrating arrangement of each pixel in a pixel structure of the PDP as in FIG. 2. In FIG. 6, R (i, j), G (i, j), and B (i, j) indicate video signal data of red, green, and blue subpixels, respectively, in an i-th row and j-th column of a pixel (P_{i,j}).

As shown in FIG. 5, the controller 200 includes a rendering processor 210 and a feedback processor 220, and may further include an inverse gamma corrector (not shown) for performing inverse gamma correction of input image data.

The rendering processor 210 converts video signal data of upper and lower pixels of a black horizontal line, a white horizontal line, a black vertical line, or a white vertical line to video signal data that is magenta-biased or cyan-biased by mixing a predetermined ratio of upper or lower video signal data of a pixel in the input image data or data that are corrected by the inverse gamma corrector and performing a rendering process of the mixed data.

Next, a method of performing a rendering process in the rendering processor 210 is described in detail.

In the pixel arrangement of FIG. 6, in an i-th row and a j-th column of pixel (P_{i,j}), video signal data R(i, j), G(i, j), and B(i, j) are converted to video signal data R′(i, j), G′(i, j), and B′(i, j) by performing a rendering process in a method as in Equations 1 to 3.

R′(i, j)=R(i, j)×m/(m+n)+R(i+1, j)×n/(m+n) Equation 1

G′(i, j)=G(i, j)×m/(m+n)+G(i−1, j)×n/(m+n) Equation 2

B′(i, j)=B(i, j)×m/(m+n)+B(i+1, j)×n/(m+n) Equation 3

In Equations 1 to 3, m has a value greater than n, and m and n are values that are set considering an effect of adjacent upper and lower subpixels and are set to display an optimum image. Here, because m is a value greater than n, the converted video signal data are greatly influenced by the original video signal data.

As shown in Equation 1, the converted video signal data R′(i, j) is formed by combining original video signal data R (i, j) and R (i+1, j) in a predetermined ratio. That is, the video signal data R′(i, j) is influenced by video signal data R(i+1, j) of a red subpixel of a pixel of an (i+1)-th row, which is an adjacent row.

As shown in Equation 2, the converted video signal data G′(i, j) is formed by combining original video signal data G(i, j) and G(i−1, j) in a predetermined ratio. That is, unlike the video signal data R′(i, j), the video signal data G′(i, j) is influenced by video signal data G(i−1, j) of a green subpixel of a pixel of the (i−1)-th row, which is an adjacent row.

As shown in Equation 3, the converted video signal data B′(i, j) is formed by combining original video signal data B(i, j) and B(i+1, j) in a predetermined ratio. That is, the converted video signal data B′(i, j) is influenced by video signal data B(i+1, j) of a blue subpixel of a pixel of the (i+1)-th row, which is an adjacent row.

Next, in an i-th row and (j+1)-th column of pixel (P_{i,j+1}), video signal data R(i, j+1), G(i, j+1), B(i, j+1) are converted to video signal data R′(i, j+1), G′(i, j+1), B′(i, j+1) by performing a rendering processing in a method as in Equations 4 to 6.

R′(i, j+1)=R(i, j+1)×m/(m+n)+R(i−1, j+1) ×n/(m+n) Equation 4

G′(i, j+1)=G(i, j+1)×m/(m+n)+G(i+1, j+1)×n/(m+n) Equation 5

B′(i, j+1)=B(i, j+1)×m/(m+n)+B(i−1, j+1)×n/(m+n) Equation 6

In Equations 4 to 6, m has a value greater than n, and m and n are values that are set considering an effect of adjacent upper and lower subpixels and are set to display an optimum image. Referring to FIG. 6, because the subpixel arrangement of a (j+1)-th column of a pixel has a different order from the subpixel arrangement of a j-th column of a pixel, surrounding subpixels are affected differently, as shown in Equations 4 to 6.

As shown in Equation 4, the converted video signal data R′(i, j+1) is formed by combining original video signal data R(i, j+1) and R(i−1, j+1) in a predetermined ratio. That is, the converted video signal data R′(i, j+1) are influenced by video signal data R(i−1, j+1) of a red subpixel of a pixel of the (i−1)-th row, which is an adjacent row.

As shown in Equation 5, the converted video signal data G′(i, j+1) is formed by combining original video signal data G(i, j+1) and G(i+1, j+1) in a predetermined ratio. That is, unlike the video signal data R′(i, j+1), the video signal data G′(i, j+1) is influenced by video signal data G(i+1, j+1) of a green subpixel of a pixel of the (i+1)-th row, which is an adjacent row.

As shown in Equation 6, the converted video signal data B′(i, j+1) is formed by combining original video signal data B(i, j+1) and B(i−1, j+1) in a predetermined ratio. That is, the video signal data B′(i, j+1) is influenced by video signal data B(i−1, j+1) of a blue subpixel of a pixel of the (i−1)-th row, which is an adjacent row.

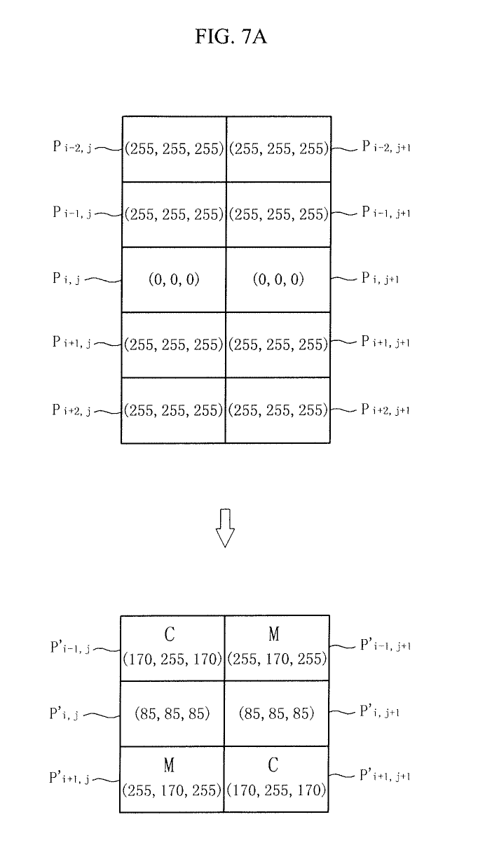

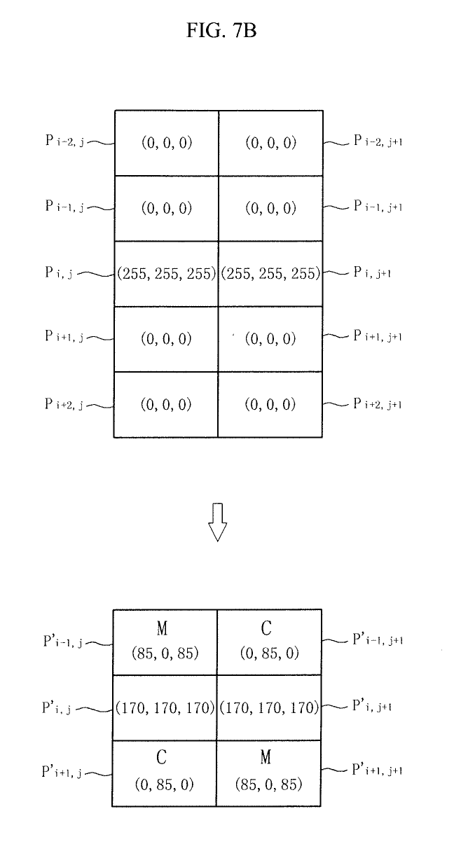

FIGS. 7A and 7B are views illustrating an example in which a rendering method according to an exemplary embodiment of the present invention is applied to a predetermined video signal data. FIG. 7A is a view illustrating a case of applying Equations 1 to 6 to video signal data for displaying a black horizontal line, and FIG. 7B is a view illustrating a case of applying Equations 1 to 6 to video signal data for displaying a white horizontal line. In FIGS. 7A and 7B, values within parentheses display video signal data of a red subpixel, a green subpixel, and a blue subpixel in order. It is assumed that m=2 and n=1 in Equations 1 to 6. In FIGS. 7A and 7B, the converted data for pixels P_{i-2,j}, P_{i-2,j+1,} P_{i+2,j}, P_{i+2,j+1} are determined by adjacent pixels and thus are not displayed for convenience.

Referring to FIG. 7A, if Equations 1 to 3 are applied to video signal data of a pixel P_{i-1,j}, P_{i-1,j}=255, 255, 255 are converted to P′_{i-1,j}=170, 255, 170, and if Equations 4 to 6 are applied to video signal data of a pixel P_{i+1,j+1}, P_{i+1,J+1}=255, 255, 255 are converted to P′_{i+1,j+1}=170, 255, 170. That is, in the pixels P_{i-1,j}, P_{i+1,j+1}, original video signal data are converted to video signal data that is cyan-biased. In general, when original video signal data are converted to video signal data that is cyan-biased, an average ((ΔR+ΔB)/2) of a change amount of video signal data of red and blue subpixels is greater than a change amount (ΔG) of video signal data of a green subpixel. In other words, when video signal data of red and blue subpixels decrease or video signal data of a green subpixel increase, original video signal data are converted to video signal data that is cyan-biased. In pixels of P_{i-1,j}, P_{i+1,j+1}, because video signal data of red and blue subpixels become smaller than original video signal data, original video signal data are converted to video signal data that is cyan-biased.

If Equations 4 to 6 are applied to video signal data of a pixel P_{i-1,j+1}, P_{i-1,j+1}=255, 255, 255 are converted to P′_{i-1,j+1}=255, 170, 255, and if Equations 1 to 3 are applied to video signal data of a pixel P_{i+1,j}, P_{i+1,j}=255, 255, 255 are converted to P′_{i+1,j}=255, 170, 255. That is, in pixels P_{i-1,j+1}, P_{i+1,j}, original video signal data are converted to video signal data that is magenta-biased. In general, when original video signal data are converted to video signal data that is magenta-biased, a change amount (ΔR+ΔB/2) of video signal data of red and blue subpixels is smaller than a change amount (ΔG) of video signal data of a green subpixel. In other words, when video signal data of a green subpixel decreases or video signal data of red and blue subpixels increase, original video signal data are converted to video signal data that is magenta-biased. In pixels of P_{i-1,j+1}, P_{i+1,j}, because video signal data of a green subpixel decrease, original video signal data are converted to video signal data that is magenta-biased.

If Equations 1 to 3 are applied to video signal data of the pixel P_{i,j}, P_{i,J}=0, 0, 0 are converted to P′_{i,j}=85, 85, 85, and if Equations 4 to 6 are applied to video signal data of the pixel P_{i,j+1}, P_{i,j+1}=0, 0, 0 are converted to P′_{i,j+1}=85, 85, 85. That is, a color of video signal data of pixels P_{i,j}, P_{i,j+1} corresponding to a black horizontal line is not converted and only a luminance level thereof is converted from black to light black.

Referring to FIG. 7B, if Equations 1 to 3 are applied to video signal data of the pixel P_{i-1,j}, P_{i-1,j}=0, 0, 0 are converted to P′_{i,j-1}=85, 0, 85, and if Equations 4 to 6 are applied to video signal data of the pixel P_{i+1,j+1}, P_{i+1,j+1}=0, 0, 0 are converted to P′_{i+1,j+1}=85, 0, 85. That is, in pixels P_{i-1,j}, P_{i+1,j+1}, original video signal data are converted to video signal data that is magenta-biased. In pixels P_{i-1,j}, P_{i+1,j+1}, because video signal data of red and blue subpixels become greater than that of original video signal data, the original video signal data are converted to video signal data that is magenta-biased.

If Equations 4 to 6 are applied to video signal data of the pixel P_{i-1,j+1}, P_{i-1,j+1}=0, 0, 0 are converted to P′_{i-1,j+1}=0, 85, 0, and if Equations 1 to 3 are applied to video signal data of the pixel P_{i+1,j}, P_{i+1,j}=0, 0, 0 are converted to P′_{i+1,j}=0, 85, 0. That is, in pixels P_{i-1,j+1}, P_{i+1,j}, original video signal data are converted to video signal data that is cyan-biased. In pixels P_{i-1,j+1}, P_{i+1,j}, because video signal data of a green subpixel increase, original video signal data are converted to video signal data that is cyan-biased.

If Equations 1 to 3 are applied to video signal data of the pixel P_{i,j}, P_{i,j}=255, 255, 255 are converted to P′_{i,j}=170, 170, 170, and if Equations 4 to 6 are applied to video signal data of the pixel P_{i,j+1}, P_{i,j+1}=255, 255, 255 are converted to P′_{i,j+1}=170, 170, 170. A color of video signal data of pixels P_{i,j}, P_{i,j+1} corresponding to a white horizontal line is not converted and only a luminance level thereof is converted from white to dark white.

As shown in FIGS. 7A and 7B, when a rendering method is applied according to an exemplary embodiment of the present invention, video signal data of upper and lower pixels adjacent to a black horizontal line or a white horizontal line are converted to video signal data that is magenta-biased or cyan-biased. Accordingly, when a rendering method according to an exemplary embodiment of the present invention is applied, a problem that a black horizontal line or a white horizontal line looks like a zigzag shape can be solved.

However, when a rendering method is applied, a color of a pixel corresponding to a black horizontal line is not converted but the color is converted to light black and a color of a pixel corresponding to a white horizontal line is also not converted but the color is converted to dark white. Accordingly, visibility of a black horizontal line or a white horizontal line is deteriorated.

In order to solve deterioration of visibility, a feedback processor 220 of FIG. 5 reconverts video signal data of portions corresponding to a black horizontal line or a white horizontal line to original video signal data. The feedback processor 220 obtains a dispersion of original video signal data of each pixel and a dispersion of the converted video signal data of each pixel and then determines whether to convert the converted video signal data to original video signal data according to a degree of a change amount of the dispersion. That is, when a dispersion of the converted video signal data is equal to or smaller than a dispersion of original video signal data, the feedback processor 220 reconverts the converted original video signal data to the original video signal data. Here, a dispersion of video signal data of each pixel means a dispersion between video signal data of subpixels (i.e., red, green, and blue subpixels) of each pixel.

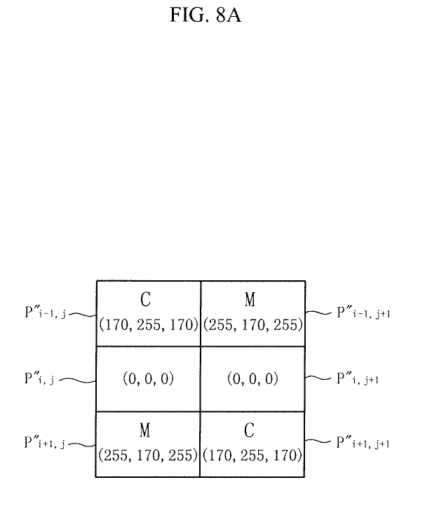

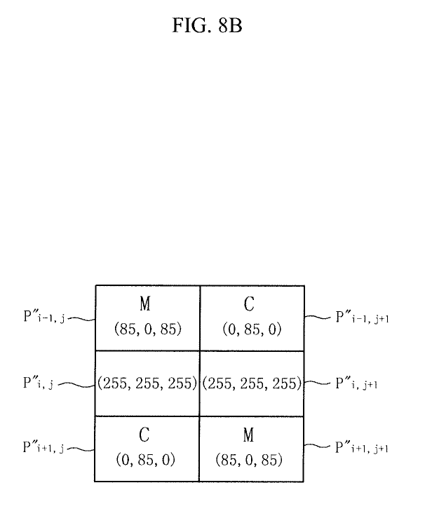

As shown in FIG. 7A, video signal data of pixels (i.e., P_{i,j}, P_{i,j+1}) corresponding to the black horizontal line are converted from P_{i,j}, P_{i,j+1}=0, 0, 0 to P′_{i,j}, P′_{i,j+1}=85, 85, 85 by the rendering processor 210. Because a dispersion of data 0, 0, 0 is 0 and a dispersion of data 85, 85, 85 is 0, a dispersion change amount of pixels P_{i,j}, P_{i,j+1} is 0. Accordingly, as shown in FIG. 8A, P′_{i,j}, P′_{i,j+1}=85, 85, 85 are reconverted to P″_{i,j}, P″_{i,j+1}=0, 0, 0 by the feedback processor 220. In FIG. 7A, in the remaining pixels, because a dispersion of the converted video signal data becomes greater than that of original video signal data, the converted video signal data are not reconverted to original video signal data as shown in FIG. 8A.

Referring to FIGS. 7B and 8B, in pixels (i.e., P_{i,j}, P_{i,j+1}) corresponding to a white horizontal line, because a dispersion (i.e., 0) of the converted video signal data is equal to a dispersion (i.e., 0) of original video signal data, in a pixel corresponding to a white horizontal line, data 170, 170, 170 are reconverted to original video signal data 255, 255, 255. In FIG. 7B, because a dispersion of the converted video signal data becomes greater than that of original video signal data in the remaining pixels, the converted video signal data are not reconverted to original video signal data as shown in FIG. 8B.

The feedback processor 220 can use the mixed data by mixing video signal data that are converted by the rendering processor 210 and original video signal data using a weight value according to a degree of a change amount of a dispersion.

FIG. 8A is a view illustrating final video signal data of the video signal data as in FIG. 7A, and FIG. 8B is a view illustrating final video signal data of the video signal data as in FIG. 7B. As shown in FIG. 8A, in the video signal data as in FIG. 7A, cyan and magenta are alternately arranged in pixels around a black horizontal line. As shown in FIG. 8B, in the video signal data as in FIG. 7B, magenta and cyan are alternately arranged in pixels around a white horizontal line. That is, video signal data are converted as in FIGS. 3A and 4A by the rendering processor 210 and the feedback processor 220.

In the black vertical line and the white vertical line, if Equations 1 to 6 are applied by the rendering processor 210 and a processing is performed by the feedback processor 220, video signal data are converted as in FIGS. 3B and 4B.

In image processing data that are processed by the rendering processor 210 and the feedback processor 220, a phenomenon that horizontal lines looks like a zigzag shape can be prevented even in a structure in which centers of the subpixels form a triangle as in a PDP according to an exemplary embodiment of the present invention. Accordingly, visibility and readability of a character can be increased.

In an exemplary embodiment of the present invention, an image processing method of increasing visibility and readability of a character in a structure of a PDP in which centers of subpixels form a triangle and a shape of a discharge cell (i.e., a subpixel) is a hexagonal plane shape is described. However, the present invention can be applied to a structure of a PDP in which a shape of one discharge cell, in which centers of subpixels form a triangle, is a rectangular flat shape or has other shapes.

In an exemplary embodiment of the present invention, an image processing method of increasing visibility and readability of a character in a plasma display device including a PDP in which centers of subpixels form a triangle is described. However, the present invention can be applied to other display devices, for example a liquid crystal device (LCD) and a field emission device (FED) in which centers of subpixels form a triangle.

According to an exemplary embodiment of the present invention, visibility and readability of a character can be increased by converting video signal data of upper and lower pixels adjacent to a black line or a white line to video signal data having a magenta-biased or cyan-biased color.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A driving method of a display device having a plurality of pixels, each of the plurality of pixels having three subpixels, centers of the three subpixels forming a triangle having a side parallel to a horizontal direction of a display image, the driving method comprising:
converting first unprocessed video signal data of at least one upper pixel adjacent to a black line or a white line among the plurality of pixels to first processed video signal data that is cyan-biased or magenta-biased when the black line or the white line is to be displayed on at least one pixel in the horizontal direction of the display image;
converting second unprocessed video signal data of at least one lower pixel adjacent to the black line or the white line among the plurality of pixels to second processed video signal data that is cyan-biased or magenta-biased when the black line or the white line is to be displayed; and
displaying the first processed video signal data and the second processed video signal data on the display device.

2. The driving method of claim 1, wherein said converting the first unprocessed video signal data comprises converting the first unprocessed video signal data such that the first processed video signal data includes cyan-biased data and magenta-biased data alternately arranged.

3. The driving method of claim 2, wherein said converting the second unprocessed video signal data comprises converting the second unprocessed video signal data such that the second processed video signal data includes magenta-biased data and cyan-biased data alternately arranged.

4. The driving method of claim 3, wherein when the first processed video signal data is cyan-biased, the second processed video signal data is magenta-biased, and when the first processed video signal data is magenta-biased, the second processed video signal data is cyan-biased, said at least one lower pixel being located vertically below said at least one upper pixel.

5. The driving method of claim 1, further comprising:
when the black line is a vertical black line or the white line is a vertical white line, and the vertical black line or the vertical white line is displayed including the at least one pixel and is displayed having a vertical direction crossing the horizontal direction, converting the first unprocessed video signal data of said at least one upper pixel adjacent to the vertical black line or the vertical white line to the first process video signal data that is cyan-biased and converting the second unprocessed video signal data of said at least one lower pixel adjacent to the vertical black line or the vertical white line to the second processed video signal data that is magenta-biased.

6. The driving method of claim 1, wherein the three subpixels comprise a green subpixel, a red subpixel, and a blue subpixel, and when the first processed video signal data and the second processed video signal data are cyan-biased, a change of an amount of color of the green subpixel from the first unprocessed video signal data and the second unprocessed video signal data is smaller than an average of a change of an amount of color of the red subpixel and the blue subpixel from the first unprocessed video signal data and the second unprocessed video signal data.

7. The driving method of claim 1, wherein the three subpixels comprise a green subpixel, a red subpixel, and a blue subpixel, and when the first processed video signal data and the second processed video signal data are magenta-biased, a change of an amount of color of the green subpixel from the first unprocessed video signal data and the second unprocessed video signal data is greater than an average of a change of an amount of color of the red pixel and the blue pixel from the first unprocessed video signal data and the second unprocessed video signal data.

8. The driving method of claim 1, wherein said converting the first unprocessed video signal data includes converting the first unprocessed video signal data of said at least one upper pixel by reflecting video signal data of pixels that are adjacently above and below said at least one upper pixel, among the pixels, to video signal data of said at least one upper pixel; and
said converting the second unprocessed video signal data includes converting the second unprocessed video signal data of said at least one lower pixel by reflecting video signal data of pixels that are located adjacently above and below said at least one lower pixel, among the pixels, to video signal data of said at least one lower pixel.

9. The driving method of claim 8, wherein original video signal data are displayed corresponding to the black line or the white line.

10. The driving method of claim 1, wherein the black line is a vertical line including at least one pixel among the pixels that is darker than a luminance of surrounding said pixels and the white line is a vertical line including at least one pixel among the pixels that is lighter than a luminance of surrounding said pixels, or the black line is a horizontal line including at least one pixel among the pixels that is darker than a luminance of surrounding said pixels and the white line is a horizontal line including at least one pixel among the pixels that is lighter than a luminance of surrounding said pixels.

11. The driving method of claim 1, wherein the first unprocessed video signal data and the second unprocessed video signal data are input from outside or from video signal data in which gamma correction is performed.

12. A driving method of a display device having a plurality of pixels, each of the plurality of pixels having three subpixels, centers of the three subpixels forming a triangle having a side parallel to a horizontal direction of a display image, the driving method comprising:
converting unprocessed video signal data to processed video signal data for each of the plurality of pixels by reflecting the unprocessed video signal data of upper and lower pixels, among the plurality of pixels, adjacent to each of the plurality of pixels;
calculating a first dispersion using the unprocessed video signal data for each of the plurality of pixels, the first dispersion being a dispersion between the subpixels of each of the plurality of pixels;
calculating a second dispersion using the processed video signal data, the second dispersion being a dispersion between the subpixels of each of the plurality of pixels; and
converting the processed video signal data of one or more of the plurality of pixels to the unprocessed video signal data when the second dispersion is less than or equal to the first dispersion for said one or more of the plurality of pixels.

13. The driving method of claim 12, wherein the first dispersion is calculated using the unprocessed video signal data of the three subpixels, and the second dispersion is calculated using the processed video signal data of the three subpixels.

14. The driving method of claim 12, wherein said converting the unprocessed video signal data of each of the plurality of pixels includes converting the unprocessed video signal data of the three subpixels of the adjacent upper and lower pixels to the processed video signal data of each of the plurality of pixels by reflecting in a predetermined ratio with identical colors in the subpixels of each of the plurality of pixels.

15. The driving method of claim 12, wherein when a black horizontal line or a white horizontal line is displayed, the black horizontal line or the white horizontal line including at least one of the plurality of pixels and being parallel to the horizontal direction of the display image, converting the unprocessed video signal data of upper and lower pixels adjacent to the black horizontal line or the white horizontal line to the processed video signal data that is cyan-biased or magenta-biased.

16. The driving method of claim 15, wherein when converting the processed video signal data to the unprocessed video signal data, the processed video signal data of each of the plurality of pixels corresponding to the black horizontal line or the white horizontal line are converted back to the unprocessed video signal data.

17. A display device comprising:
a display panel having a plurality of row electrodes extending in a first direction, a plurality of column electrodes extending in a second direction perpendicular to the first direction and a plurality of pixels defined by the plurality of row electrodes and the plurality of column electrodes, each of the plurality of pixels including three subpixels with centers forming a triangle having a side parallel to the first direction;
a controller for generating a control signal for driving the plurality of row electrodes and the plurality of column electrodes using input video signal data; and
a driver for driving the plurality of row electrodes and the plurality of column electrodes according to the control signal;
wherein the controller converts unprocessed video signal data of upper and lower pixels adjacent to a black or white line to processed video signal data that is cyan-biased or magenta-biased, when the black or white line which includes at least one pixel is displayed.

18. The display device of claim 17, wherein the controller is further adapted to:
convert the unprocessed video signal data of the upper pixel such that the processed video signal data that is cyan-biased and the processed video signal data that is magenta-biased are alternately arranged in the upper pixel adjacent to the black or white line, and
convert the unprocessed video signal data of a lower pixel such that the processed video signal data that is magenta-biased and the processed video signal data that is cyan-biased are alternately arranged in the lower pixel adjacent to the black or white line.

19. The display device of claim 17, wherein the controller is further adapted to:
convert the unprocessed video signal data of the upper and lower pixels adjacent to a black horizontal line or a white horizontal line to processed video signal data that is cyan-biased or magenta-biased, when the black horizontal line or the white horizontal line, which includes at least one pixel and whose direction is the same as the first direction, is displayed.

20. The display device of claim 19, wherein the controller is further adapted to:
convert video signal data of the upper pixel such that the processed video signal data that is magenta-biased and the processed video signal data that is cyan-biased are alternately arranged in the upper pixel adjacent to the black horizontal line or the white horizontal line, and
convert the unprocessed video signal data of the lower pixel such that the processed video signal data that is cyan-biased and the processed video signal data that is magenta-biased are alternately arranged in the lower pixel adjacent to the black horizontal line or the white horizontal line.

21. The display device of claim 19, wherein the black horizontal line includes one pixel among the plurality of pixels that is darker than a luminance of surrounding pixels and the white horizontal line includes one pixel among the plurality of pixels that is lighter than the luminance of surrounding said pixels.

22. The display device of claim 17, wherein the controller is further adapted to:
convert unprocessed video signal data of an upper pixel, among the plurality of pixels, adjacent to a black vertical line or a white vertical line to processed video signal data that is cyan-biased and convert unprocessed video signal data of a lower pixel, among the plurality of pixels, adjacent to the black vertical line or the white vertical line to processed video signal data that is magenta-biased, when the black vertical line or the white vertical line, which includes at least one pixel and whose direction intersects the first direction, is displayed.

23. The display device of claim 17, wherein the three subpixels comprise a green subpixel, a red subpixel, and a blue subpixel, and
in the processed video signal data that is cyan-biased, a change of an amount of color of the green subpixel from the unprocessed video signal data is less than an average of a change of an amount of color of the red subpixel and the blue subpixel from the unprocessed video signal data; and
in the processed video signal data that is magenta-biased, a change of an amount of color of the green subpixel from the unprocessed video signal data is greater than an average of a change of an amount of color of the red subpixel and the blue subpixel from the unprocessed video signal data.

24. The display device of claim 17, wherein the controller comprises:
a rendering processor for converting the unprocessed video signal data of each of the plurality of pixels by reflecting the unprocessed video signal data of upper and lower pixels adjacent to each of the plurality of pixels; and
a feedback processor for calculating a first dispersion and a second dispersion, the first dispersion being a dispersion between the three subpixels of each of the plurality of pixels using the unprocessed video signal data, the second dispersion being a dispersion between subpixels of each of the plurality of pixels using the processed video signal data converted by the rendering processor, and for converting the processed video signal data to the unprocessed video signal data when the second dispersion is equal to or less than the first dispersion.

25. The display device of claim 24, wherein the processed video signal data of each of the plurality of pixels corresponding to the line are converted to unprocessed video signal data by the feedback processor.

26. The display device of claim 25, wherein each of the three subpixels has a hexagonal flat shape.

27. The display device of claim 17, wherein two of the three subpixels correspond to the same row electrode.
